(19) United States
(12) Patent Application Publication
(10) Pub. No.: US 2014/0230650 A1
(43) Pub. Date: Aug. 21, 2014

(54) METHOD TO RETROFIT SYSTEM WITH ENHANCED CAPACITY FOR REMOVING MERCURY FROM A PRODUCED HYDROCARBON FLUID.

(71) Applicant: Feng-Ran Sheu, Sugar Land, TX (US)

(72) Inventor: Feng-Ran Sheu, Sugar Land, TX (US)

(73) Assignee: Chevron U.S.A. Inc., San Ramon, CA (US)

(21) Appl. No.: 14/185,689

(22) Filed: Feb. 20, 2014

Related U.S. Application Data
(60) Provisional application No. 61/767,139, filed on Feb. 20, 2013.

(51) Int. Cl. B01D 53/04; B01D 53/26

(52) U.S. Cl. CPC B01D 53/04; B01D 53/261
USPC 95/119; 96/132

(57) ABSTRACT

A method for retrofitting a system for removing mercury and water from a gas stream is disclosed. A system is provided including a first water removal unit and a second mercury removal unit in fluid communication with the first water removal unit. The first water removal unit has a fixed capacity or reservoir for containing mole sieves for removing water from a gas stream. The second mercury removal unit has a fixed capacity or reservoir for containing mole sieves for removing mercury from the gas stream. The second mercury removal unit is filled with mole sieves adapted for removing mercury from a gas stream containing mercury. The first water removal unit is retrofit by replacing a first portion of mole sieves adapted for removing water from the gas stream with a second portion of mole sieves adapted for removing mercury. The capacity of the system for removing mercury is thereby enhanced relative to a system of the same size wherein the first water removal unit is filled with water removing mole sieves and no mercury removing mole sieves.

### FIELD OF THE INVENTION

This application claims the benefit of U.S. provisional patent application Ser. No. 61/767,139 filed on Feb. 20, 2013 the disclosures of which are incorporated herein by reference. The present invention relates generally to apparatus and methods for removing mercury from a gas stream containing water and mercury such as a stream separated from produced hydrocarbon fluids received from an underground reservoir, and more particularly, to apparatus and methods for retrofitting systems containing dehydration and mercury removal units.

### BACKGROUND OF THE INVENTION

Examples of production facilities for handling hydrocarbon containing gases include liquefied natural gas (LNG) facilities where gas is liquefied at cryogenic temperatures, gas-to-liquids (GTL) plants where gases such as methane are catalytically converted to liquid hydrocarbons and compressed natural gas (CNG) where gas is compressed to high pressure for transportation. During well appraisal stages of planning for such production facilities estimates are made of the quantities and concentrations of hydrocarbon contents, such as hydrocarbon gases and liquids, produced water, acid gases such as carbon dioxide and hydrogen sulfide, and other contaminants such as mercury.

These production facilities for processing the hydrocarbon containing fluids produced from underground reservoirs are often designed well in advance of actual wells being drilled and fluids being produced. As a consequence, the capacity of the designed treating facility may not be sufficient to handle certain contaminants, such as mercury)(Hg°), as originally designed. In certain cases, such as with offshore platforms or land based facilities in environmentally sensitive areas, the footprint of production facilities can be difficult to change without having to make major redesigns. The present invention addresses retrofitting a portion of a production facility wherein the footprint of a design need not be changed while still accommodating an increased capacity in Hg removal and maintaining the planned life of a dehydration and mercury removal system.

### SUMMARY OF THE INVENTION

A method for retrofitting a system for removing mercury and water from a gas stream is disclosed. An existing system includes a first water removal unit and a second mercury removal unit in fluid communication with the first water removal unit. The first water removal unit has a fixed capacity or reservoir for containing adsorbents such as mole sieves for removing water from a gas stream. The second mercury removal unit has a fixed capacity or reservoir for containing adsorbents such as activated carbon, mole sieves or metal sulfides, for removing mercury from the gas stream. For retrofitting the system to treat the gas with a higher mercury concentration than originally anticipated, the first water removal unit is provided with two types of adsorbents; one is an preferably an adsorbent for water removal and the second absorbent, such as a metal coating mole sieve, is adapted to remove mercury or both water and mercury. For example, the first water removal unit is filled with a first or upstream portion of mole sieves adapted for removing water from the gas stream and a second or downstream portion of mole sieves, such as with a metal coating adapted for removing mercury and water. The capacity of the retrofitted system for removing mercury is enhanced relative to the existing system of the same size wherein the first or original water removal unit is designed to be filled with water removing mole sieves or adsorbents and not mercury removing mole sieves or adsorbents.

In one embodiment, the mercury removing adsorbents are disposed of at the end of their estimated life. In an alternative embodiment, the mercury removing adsorbents and water removing adsorbents can be regenerated concurrently and are disposed in the water removal unit. The water removing capability and bed life of the first water removal unit of the retrofitted unit will ideally be the same as that of the existing unit which is used to absorb water only.

In one retrofit embodiment, the first water removal unit contains at least 10% mercury removing mole sieves by volume. In another embodiment, the first retrofit water removal unit contains at least 20% mercury removing mole sieves by volume. In a third embodiment, the first retrofit water removal unit contains at least 30% mercury removing mole sieves by volume. In a fourth embodiment, the first retrofit water removal unit contains at least 50% mercury removing mole sieves by volume. The percentage of mercury removing mole sieves required is related to the increased mercury concentration in the plant inlet gas over the earlier planned concentration or amount of mercury. For example, the percentage may be proportionally increased with the increased concentration of Hg in the gas stream.

The first water removal unit may include an existing mole sieve regeneration system which can be also used to regenerate the water removing and mercury removing mole sieves for the retrofit system. For example, the regeneration unit will remove water and mercury from the first water removal unit in a regeneration step.

Also disclosed is a water dehydration and Hg removal system. The first water and Hg removal unit has a first water removal reservoir filled with water removal mole sieves and a second Hg removal reservoir filled with Hg removal mole sieves. Downstream there from is a second Hg removal unit in fluid communication with the first water and Hg removal unit. The second Hg removal unit has a Hg removal reservoir filled with Hg removal mole sieves.

### BRIEF DESCRIPTION OF THE DRAWINGS

These and other objects, features and advantages of the present invention will become better understood with regard to the following description, pending claims and accompanying drawings where:

FIG. 1 is a schematic illustration of a conventional system used for water and mercury removal from a natural gas treatment facility; and

FIG. 2 is schematic illustration of an embodiment of the present invention wherein a water dehydration unit is retrofit to include both water and mercury removal adsorbents thereby increasing the mercury removal capacity of the system relative to the system of FIG. 1.

### DETAILED DESCRIPTION OF THE INVENTION

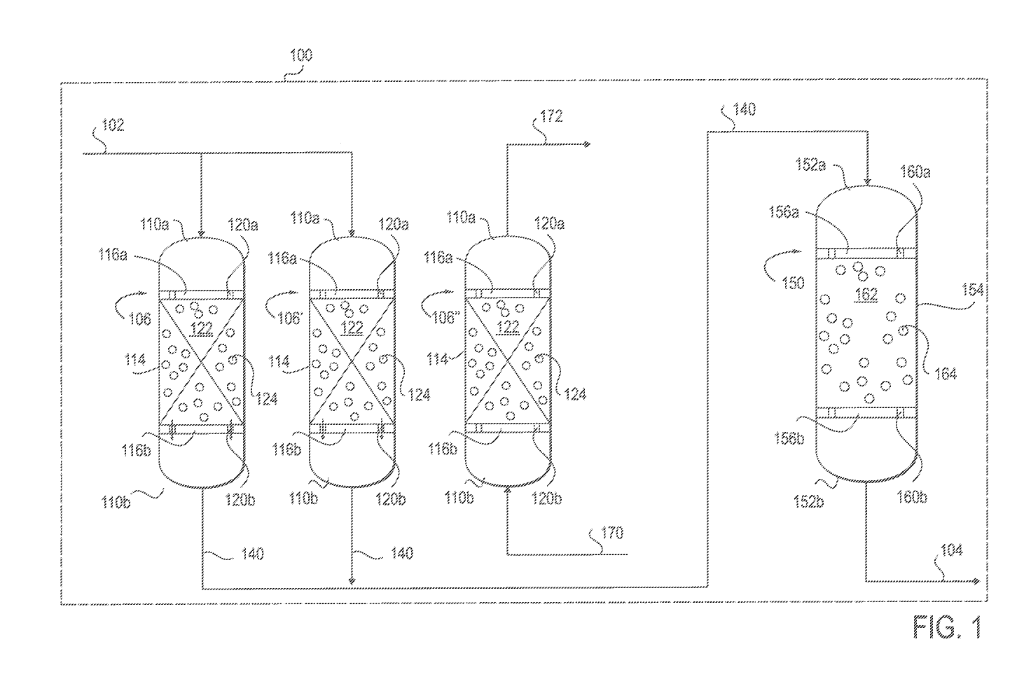

FIG. 1 shows a conventional or existing dehydration and mercury removal system 100. Sweet gas 102 is introduced to system 100 from which water and Hg is removed leaving a dried and Hg depleted gas stream 104 which exits system 100. Sweet gas is a gas that has previously had sour gases, such as hydrogen sulfide and carbon dioxide, removed from hydrocarbon containing gas stream. Ideally, gas stream 104 is greatly depleted in water and Hg content as compared to sweet gas 102.

System 100 includes three bed vessels 106, 106′ and 106″ which are used to remove water and are generally similar in construction. Of course, other similar systems can be designed with more or fewer vessels and are within the scope of this invention. In this exemplary embodiment, the first and second dehydration vessels 106 and 106′ are to be operated in a water absorption mode while the third vessel 106″ is operated in regeneration mode wherein water is stripped from vessel 106″. Each of dehydration vessel 106, 106′ and 106″ includes domed upper and lower end caps 110a and 110b which are secured relative to cylinders 114. Upper and lower end plates 116a and 116b having perforations 120a and 120b therein. Cylinders 114 and upper and lower end plates 116a and 116b define reservoirs 122 in which dehydration mole sieves or adsorbents 124 are contained or packed.

Dehydration mole sieves 124 can be selected from a wide variety of types and shapes of mole sieves adapted to capture water molecules thereon. A “molecular sieve” refers to a material containing tiny pores of a precise and substantially uniform size. In the present context, such sieves are used as an adsorbent for water removal from gases. Molecular sieves often consist of solid materials and not polymeric materials. Exemplary materials include alumino-silicate minerals, clays, porous glasses, micro-porous charcoals, zeolites, active carbons, or synthetic compounds that have open structures through which small molecules, such as nitrogen and water, can diffuse. Polar molecules (such as water molecules) that are small enough to pass into the pores are adsorbed, while slightly polarizable molecules (such as methane and nitrogen), as well as larger molecules (e.g., propane and butane) flow around the particles and crystallites, and are thus passed downstream. In the present embodiment, the molecular sieves adsorb water molecules and allow light gases to pass through.

System 100 also includes a mercury removal unit (MRU) 150. MRU 150 includes domed upper and lower end caps 152a and 152b which are attached relative to an intermediate cylinder 154. Upper and lower end plates 156a and 156b have perforations 160a and 160b therein. A reservoir 162 is formed by upper and lower end plates 156a and 156b and cylinder 154. Hg removal adsorbents 164 are captured within reservoir 162. While only a single vessel is shown in this embodiment, those skilled in the art will appreciate mercury removal units can be constructed one or more of such vessels and are within the scope of the present invention.

Hg removal adsorbents 164 may also be selected from a wide variety of commercially available adsorbents such as activated carbon or metal sulfides for removing Hg from a gas stream. By way of example and not limitation, Hg removal adsorbents 164 may be selected from those listed in patents such as Mercury absorbent carbon—EP0271618A, Mercury adsorbent carbons and carbon molecular sieves—EP0145539B and Removal of heavy metals from hydrocarbon gases EP2346592A.

In operation, a stream of sweet gas 102 is introduced to system 100. Sweet gas 102 enters dehydration units 106 and 106′ through end caps 110a and passes through perforations 120a to enter reservoirs 122. As gas stream 102 passes through reservoir 122, water is absorbed onto dehydration mole sieves 124 producing a dried gas stream 140. Dried gas stream 140 passes out of perforations 120b and end caps 110b with dried gas stream 140 then being routed to MRU 150. Dried gas stream 140 enters through end cap 152a and perforations 160a in end plate 156a and enters into reservoir 162. Hg removal adsorbents 164 absorbs Hg from dried gas stream 140 producing dried and Hg depleted gas stream 104. While dehydration units 106, 106′ and MRU 150, respectively, strip out water and Hg from sweet gas stream 102, dehydration unit 106″ may be concurrently regenerated and recharged bypassing recharge stream 170 through reservoir 122. For example, recharge stream may be a hot stream of air which carries away water from the adsorbents 124 in vessel 106″. Gas stream 172 carries away water vapor from mole sieves 124 to recharge the dehydration mole sieves 124 so that they may be used again for water removal when vessel 106″ is placed into an absorption mode. Other conventional recharge streams, well known to those skilled in the art, may also be used to recharge the adsorbents by stripping away water and/or Hg from the adsorbents.

Gas stream 104 is then suitable for further gas processing such as the production of liquefied natural gas, gas-to-liquid Fischer-Tropsch products, or for production of compressed natural gas (CNG) which is suitable for transport. Alternatively, by way of example and not limitiation, gas stream 104 may be further processed and compressed for transport through pipelines.

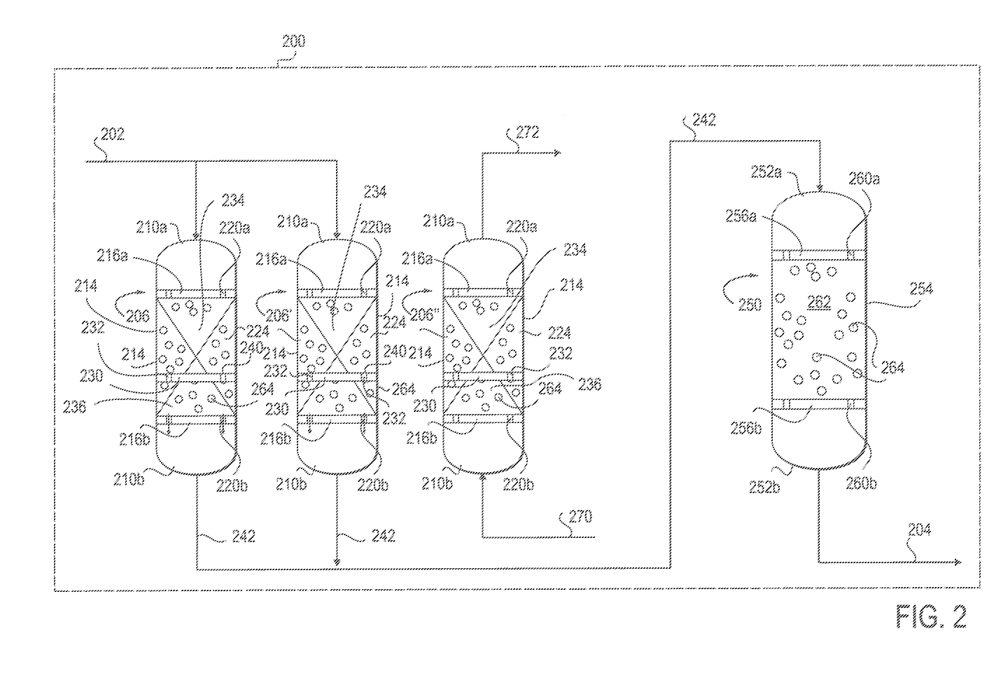

However, system 100 may be incapable of handling a Hg load in excess of what system 100 was originally designed. For example, additional produced fluid may be introduced to a production system from one or more fields that were not originally anticipated. Or else, the fields for which system 100 was originally intended to handle Hg removal may be turn out to have a much higher concentration of Hg than was originally anticipated during preliminary designs. System 200 in FIG. 2 may then be used as a retrofit of system 100 without significantly changing the available volume for the reservoirs 122 and 162 storingdehydration mole sieves and Hg removal adsorbents, respectively.

FIG. 2 shows a dehydration and mercury removal system 200 which is a retrofit of system 100. Like components from system 100 are generally incremented in reference numeral by 100.

Sweet gas 202, which may have a higher mercury concentration than sweet gas 102, is introduced to system 200 from which water and Hg is removed leaving a dried and Hg depleted gas stream 204 which exits system 200.

System 200 includes the three same dehydration vessels, now designated as vessels 206, 206′ and 206″, as was used in system 100. Vessels 206 and 206′ are used to remove water in an absorption mode while the third vessel 206″ is in the regeneration mode. Later the vessels can be placed alternatively in adsorption and recharge modes, as appropriate. Each of dehydration vessels 206, 206′ and 206″ includes domed upper and lower end caps 210a and 210b which are secured relative to cylinders 214. Upper and lower end plates 216a and 216b having perforations 220a and 220b therein. An additional intermediate plate 230 is secured relative to cylinder 214 and has perforations 232 therein. Each of intermediate plate 230 and upper end plate 216a cooperate to form an upper reservoir 234. Similarly, intermediate plate 230 cooperates with cylinder 214 and bottom end plate 216b to form a lower reservoir 236. Alternative means of separating the upper dehydration mole sieves from the lower Hg removal sieves may also be employed. By way of example and not limitation, glass beads could be used to separate the dehydration and Hg removal mole sieves instead of using perforated plate 230 in a dehydration vessels 206. Upper reservoir 234 is filled with dehydration only mole sieves 224 while lower reservoir 236 is filled with Hg removal mole sieves 264. Alternatively, adsorbents 264 may be selected to adsorb both water and Hg under appropriate adsorbtion conditions. Dehydration and Hg removal mole sieves 264 may be selected as described above with respect to system 100. Alternatively, mole sieves with greater carrying capacity for water and Hg, respectively, may be selected, albeit at greater absorbent cost than the original adsorbents or mole sieves of system 100.

System 200 also includes a mercury removal unit (MRU) 250 to remove mercury in stream 240. MRU 250 includes domed upper and lower end caps 252a and 252b which are attached relative to an intermediate cylinder 254. Upper and lower end plates 256a and 256b have perforations 260a and 260b therein. A reservoir 262 is formed by upper and lower end plates 250a and 250b and cylinder 254. Hg removal adsorbents 264 are placed within reservoir 262.

In operation, the retrofitted system 200 has sweet gas stream 202 introduced there to. Sweet gas 202 enters dehydration vessels 206 and 206′, which are in absorption mode in this exemplary embodiment, through end cap 210a and passes through perforations 220a to enter upper reservoir 234. As gas stream 202 passes through reservoir 234, water is absorbed onto dehydration mole sieves 224 producing a dried gas stream 240. Gas stream 240 passes through perforation 232 into lower reservoir 236 where a portion of Hg in the gas is removed and additional water removing is completed as well, if an absorbent is suitably selected that removes water as well as Hg.

Dried and Hg depleted gas stream 242 exits lower reservoir through perforations 220b and end caps 210b and is routed to Hg removal units 250. In Hg removal unit 250, further Hg left in the gas 242 is removed to produce stream 204 which ideally meets the specification of allowable Hg in a gas stream. Stream 242 enters through end cap 252a and perforations 260a in end plate 256a to reach reservoir 262. Hg removal adsorbents 264 strip Hg from dried gas stream 242 producing dried and Hg depleted gas stream 204. While dehydration units or vessels 206 and 206′ strip out water and a portion of Hg from sweet gas stream 202, MRU 250 completes mercury removal. Dehydration vessel 206″ can be regenerated while the other two vessels 206 and 206′ are absorbing water and Hg. For example, regeneration of mole sieves 224 and 264 can be achieved by passing recharge streams 270 through reservoirs 234, 236 in unit 206.″ Gas stream 272 carries away water vapor and Hg from mole sieves 224 and 264 during a regeneration step. Mole sieves may be used again for water and Hg removal after regeneration is completed and vessel 206′ is set into adsorption mode.

Not shown is valving which alternatively passes sweet gas 202 through vessels 206, 206′ and 206″to remove water and Hg and recharges gas 270 passes through vessels 206, 206′ and 206″ so that water and Hg may be alternately absorbed in removal stages and water and Hg stripped during recharge stages. By increasing the Hg reservoir capacity by placing Hg removing mole sieves or adsorbents in vessels 206, 206′and 206″, system 200 will have increased Hg removal capacity as compared to system 100 of FIG. 1.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention.

What is claimed is:

1. A method for retrofitting an existing system for removing mercury and water from a gas stream, the method comprising:
(a) providing a system including a first water removal unit and a second mercury removal unit in fluid communication with the first water removal unit, the first water removal unit having a fixed capacity for containing adsorbents for removing water from a gas stream and the second mercury removal unit having a fixed capacity for containing adsorbents for removing mercury from the gas stream;
(b) filling the second mercury removal unit with adsorbents s adapted for removing mercury from a gas stream containing mercury;
(c) filling the first water removal unit with a first portion of adsorbents adapted for removing water from the gas stream and a second portion of adsorbents adapted for removing mercury;
wherein the capacity of the system for removing mercury is enhanced relative to a system of the same size wherein the first water removal unit is filled with water removing adsorbents.

2. The method of claim 1 wherein:
mercury removing adsorbents are disposed with the water removing adsorbents in the water removal unit.

3. The method of claim 1 wherein:
the adsorbents added for mercury removal in the water removal unit is regenerated at the same time as adsorbents for water removal.

4. The method of claim 1 wherein:
the first water removal unit is contains at least 10% mercury removing adsorbents by volume.

5. The method of claim 1 wherein:
the first water removal unit is contains at least 20% mercury removing adsorbents by volume.

6. The method of claim 1 wherein:
the first water removal unit is contains at least 30% mercury removing adsorbents by volume.

7. The method of claim 1 wherein:
the first water removal unit is contains at least 50% mercury removing adsorbents by volume.

8. A water dehydration and Hg removal system comprising:
a. a first water and Hg removal unit having a first water removal reservoir filled with water removal adsorbents and a second Hg removal reservoir filled with Hg removal adsorbents; and
b. a second Hg removal unit in fluid communication with the first water and Hg removal unit, the second Hg removal unit having Hg removal reservoir filled with Hg removal sieves.

9. The system of claim 8 wherein:
a. the Hg removal adsorbent is activated charcoal.

10. The system of claim 8 wherein:
a. The Hg removal adsorbent comprises metal sulfide.
